(19) United States
(12) Patent Application Publication
(10) Pub. No.: US 2017/0297937 A1
(43) Pub. Date: Oct. 19, 2017

(54) METHOD FOR MANAGING A WASTEWATER TREATMENT PROCESS

(71) Applicant: XYLEM IP MANAGEMENT S.À R.L., Senningerberg (LU)

(72) Inventors: Alexis De Kerchove, Bromma (SE); Trevor Ghylin, Wauwatosa, WI (US)

(73) Assignee: XYLEM IP MANAGEMENT S.À R.L., Senningerberg (LU)

(21) Appl. No.: 15/516,250

(22) PCT Filed: Sep. 28, 2015
(86) PCT No.: PCT/IB2015/057422

§ 371 Date: Mar. 31, 2017

(30) Foreign Application Priority Data
Oct. 2, 2014 (SE) 1451169-5
Jan. 19, 2015 (SE) 1550040-8

(51) Int. Cl. C02F 3/30; C02F 3/12; C02F 3/00; C02F 1/52; C02F 103/00; C02F 101/10

(52) U.S. Cl. CPC C02F 3/308; C02F 3/006; C02F 3/1215; C02F 3/1263; C02F 1/5245; C02F 2103/005; C02F 2103/001; C02F 2101/105; C02F 2209/001; C02F 2209/08; C02F 2209/16; C02F 2209/18; C02F 2103/002

(57) ABSTRACT

A method for managing a wastewater treatment process. The method includes at least the steps of measuring an amount of at least one nitrogen-containing substance in the influent wastewater (CN, influent), and determining an amount of phosphorous to be removed from the influent wastewater (CP, influent) based on the measured amount of at least one nitrogen-containing substance in the influent wastewater (CN, influent).

### TECHNICAL FIELD OF THE INVENTION

The present invention relates generally to the field of wastewater treatment. Further, the invention relates specifically to a method for determining an amount of phosphorous to be removed from the influent wastewater.

### BACKGROUND OF THE INVENTION

Large volumes of municipal wastewater are generated on daily basis. Here, the omnibus term municipal wastewater encompasses blackwater, greywater as well as surface runoff. The generated municipal wastewater typically contains considerable amounts of pollutants such as phosphorous that originates, among others, from the use of various detergents. Average value for phosphorous concentration in the wastewater across EU is in the range 4-10 mg/L. Corresponding value in the USA is approximately 4-15 mg/L. In addition to phosphorous, the wastewater, also contains significant amounts of carbon and nitrogen.

In order to minimize its environmental impact the wastewater needs to be suitably treated prior to discharge to bodies of water such as lakes and ponds. Accordingly, the wastewater is normally processed in a wastewater treatment plant where the pollutants, including the phosphorous-containing compounds, are to the greatest possible extent removed from the liquid.

Two well-known processes for wastewater treatment are a Conventional Activated Sludge (CAS) process, comprising a plurality of receiving tanks that host different stages of the treatment process and a Sequential Batch Reactor (SBR) process where all treatment is done in a single basin.

Regardless of the process employed, the uptake of the phosphorous-containing compounds takes place during a reaction phase comprising a biological treatment phase and a subsequent chemical treatment phase.

More specifically, the biological treatment phase comprises alternating processes of oxygenation of the influent wastewater and subsequent mixing of the oxygenated influent wastewater. Oxygenation, typically by means of an aerator arrangement, creates an aerobic environment. Mixing of the oxygenated influent wastewater occurs in an anoxic process, i.e. at negligible oxygen levels and in the presence of nitrogen. Various, substance-specific populations of aerobic/anaerobic bacteria are present in the reaction vessel. Their purpose is to feed on the nitrogen, carbon and phosphorous of the influent wastewater during the biological treatment phase so as to reduce the level of the respective substance.

In this context, aerobic conditions occur when the level of dissolved oxygen is greater than 0.2 mg/L. Moreover, anoxic conditions come about when the level of dissolved oxygen is greater than 0 and less than 0.2 mg/L and the nitrate concentration is greater than 0 mg/L. Finally, anaerobic conditions are present when the level of dissolved oxygen is 0 mg/L and the nitrate concentration is 0 mg/L.

The reaction phase further includes a chemical treatment phase. The chemical treatment phase typically comprises addition of a suitable coagulant in order to precipitate phosphorous from the process liquor. It also comprises further, predominantly mechanical, treatment of the process liquor in order to bring about flocculation of the precipitated phosphorous material.

Once the reaction phase is completed, the flocculated matter, which sinking is gravity-promoted, gradually overgoes into a settled sludge blanket that also contains the biomass produced during the biological treatment phase. A fraction of the sludge is eventually evacuated from the basin, and the rest is recycled to sustain the processes taking part in the biological treatment phase.

Amongst the pollutants normally present in the influent wastewater, the phosphorous-containing compounds are most harmful to the environment why the treatment processes, as discussed above, to a great extent focus on their uptake/removal. This is mainly achieved in the chemical treatment phase of the process by introducing a suitable coagulant. The coagulants used in the chemical treatment are typically metal-based salts or rare earth-based salts. In this context, it is desirable to remove as much phosphorous as possible from the influent wastewater while keeping the dose of coagulant to a minimum. This requires rather precise information as regards the amount of phosphorous in the influent wastewater and/or the effluent wastewater.

Well-known methods of determining the amount of phosphorous in the wastewater throughout the water treatment process are based on models that focus on determining phosphorous content in wastewater influent and/or wastewater effluent. These models are in general oversimplified why the associated methods frequently generate incorrect results.

In the related context, the actual measurement of the phosphorous content, e.g. in the influent wastewater, is currently realized either as a sample analysis in laboratory environment or as an online wet-chemistry-based test. The laboratory analysis is mainly manually performed, time consuming and of limited accuracy. The wet-chemistry-based test, on the other hand, is very exact and returns results without significant time delays. However, such a test is very costly. This is the main reason why the more traditional laboratory analysis is more frequently used.

### OBJECT OF THE INVENTION

The present invention aims at obviating the aforementioned disadvantages and failings of previously known methods, and at providing an improved method for managing a wastewater treatment process. A primary object of the present invention is to provide an affordable method of the initially defined type for real-time measuring of the phosphorous content present in the influent wastewater. Another object of the present invention is to provide a method which more precisely characterizes the wastewater treatment process, in particular the biological phase that is part of the reaction phase, in order to more accurately determine the amount of coagulant needed for phosphorous removal in the chemical treatment phase.

### SUMMARY OF THE INVENTION

According to the invention at least the primary object is attained by means of the initially defined method for managing a wastewater treatment process having the features defined in the independent claim. Preferred embodiments of the present invention are further defined in the dependent claims.

Hence, according to the present invention, there is provided a method for managing a wastewater treatment process, wherein the influent wastewater contains phosphorous, said method comprising at least the steps of:
measuring an amount of at least one nitrogen-containing substance in the influent wastewater (C_{N, influent}) and
determining an amount of phosphorous to be removed from the influent wastewater (C_{P, influent}) based on the measured amount of at least one nitrogen-containing substance in the influent wastewater (C_{N, influent}).

It has been established that the amount of phosphorous in the influent wastewater is correlated with the amount of nitrogen-containing substances in the influent wastewater. As discussed above, this process parameter has historically been very difficult to determine in a simple manner and at a reasonable cost. Based on the insight that the amount of phosphorous in the influent wastewater (C_{P, influent}) and the amount of the nitrogen-containing substance in the influent wastewater (C_{N, influent}) are correlated and that the amount of the at least one nitrogen-containing substance is easily measured by means of a readily available sensor, the amount of phosphorous in the influent wastewater may be straightforwardly determined with great precision. Above correlation has been further investigated in experiments using municipal wastewater from different sites as direct influent. The experiments are more thoroughly discussed in conjunction with Example 1.

In an embodiment, the step of determining the amount of phosphorous to be removed from the influent wastewater (C_{P, influent}) further comprises subtracting a target value for the amount of phosphorous in the effluent wastewater (C_{P, target, effluent}) from the previously determined amount of phosphorous to be removed from the influent wastewater (C_{P, influent}) In a thereto related embodiment, the step of determining the amount of phosphorous to be removed from the influent wastewater (C_{P, influent}) further comprises adding a difference between the current measured value for amount of phosphorous in the effluent wastewater (C_{P, effluent}) and the target value for amount of phosphorous in the effluent wastewater (C_{P, target, effluent}) to the previously determined amount of phosphorous to be removed from the influent wastewater (C_{P, influent}).

The target value for the amount of phosphorous in the effluent wastewater (C_{P, target, effluent}) may be inferred using historical data or, more frequently, it may be imposed by the legislator in order to comply with a standard. Regardless, once said value has been set, it becomes possible to determine a more technologically and commercially relevant value for an amount of phosphorous that needs to be removed from the influent wastewater (C_{P, influent}).

In another embodiment, the step of removing the determined amount of phosphorous from the influent wastewater (C_{P, influent}) further comprises introducing an amount of coagulant during a chemical treatment phase of a reaction phase of the wastewater treatment process, wherein the introduced amount of coagulant is determined based on the previously determined amount of phosphorous to be removed from the influent wastewater (C_{P, influent}).

The introduced coagulant has a high initial reactivity why the phosphorous suspended in the influent wastewater rapidly precipitates. The coagulated particulate matter is subsequently allowed to flocculate and build clumps, predominantly containing phosphorous. Suitably adjusting coagulant distribution and particulate flocculation parameters could contribute to reducing the amount of coagulant used in the removal process.

In yet another embodiment, the step of determining the amount of phosphorous to be removed from the influent wastewater (C_{P, influent}) further comprises subtracting a value corresponding to a biological uptake of phosphorous from the previously determined amount of phosphorous to be removed from the influent wastewater (C_{P, influent}), said biological uptake of phosphorous occurring during a biological treatment phase of the reaction phase of the wastewater treatment process.

The biological uptake of phosphorous occurring during the biological treatment phase is done by bacteria. These bacteria feed on the carbonaceous substance present in the wastewater while simultaneously uptaking phosphorous and storing it under the form of adenosine triphosphate (ATP). The uptaken amount of phosphorous is dependent on the produced quantity of biomass, i.e. on the consumed amount of carbonaceous substance. In this context, the uptaken amount of phosphorous is typically expressed as correlated with a difference in the biological oxygen demand level (BOD-level) between the influent respectively effluent wastewater. Here, the difference in the BOD-level quantifies the amount of oxygen used by microorganisms such as bacteria in the oxidation of carbonaceous substance. Subtracting the value corresponding to the uptaken amount of phosphorous from the previously determined amount of phosphorous to be removed from the influent wastewater contributes to reducing the amount of coagulant used in the subsequent chemical phase. In other words, taking into account the uptake of phosphorous during this phase opens for reduction of the amount of coagulant used in the subsequent chemical phase.

In a further embodiment, the step of determining the amount of phosphorous to be removed from the influent wastewater (C_{P, influent}) further comprises subtracting a value corresponding to an uptake of phosphorous by phosphorous accumulating organisms (PAO) from the previously determined amount of phosphorous to be removed from the influent wastewater (C_{P, influent}), said uptake of phosphorous by phosphorous accumulating organisms (PAO) occurring during a biological treatment phase of the reaction phase of the wastewater treatment process.

The uptake of phosphorous by phosphorous accumulating organisms (PAO) occurs during the biological treatment phase. More specifically, in an initial anaerobic stage, the PAOs uptake carbonaceous substances, releasing cellular phosphorus through expenditure of energy. Upon aeration, i.e. in an aerobic stage, the cells of these organisms accumulate large amounts of phosphorus for use as a substrate for energy production and storage. The uptaken amount of phosphorous is dependent on the produced quantity of biomass, i.e. on the consumed amount of carbonaceous substance. The uptake of phosphorous by PAOs can be 2 to 7 times larger than that by previously discussed, conventional biological uptake. In this context, the uptaken amount of phosphorous is typically defined as correlated with a difference between the value of readily biodegradable carbon present in the influent wastewater and the value of readily biodegradable carbon present in the effluent wastewater under anaerobic conditions, said readily biodegradable carbon preferably being expressed by means of readily biodegradable chemical oxygen demand (rbCOD). Here, the difference in the rbCOD-level quantifies the amount of carbonaceous substance used by PAOs under anaerobic conditions. Subtracting the value corresponding to the uptaken amount of phosphorous from the previously determined amount of phosphorous to be removed from the influent wastewater contributes to reducing the amount of coagulant used in the subsequent chemical phase. In other words, taking into account the uptake of phosphorous during this phase opens for reduction of the amount of coagulant used in the subsequent chemical phase.

In an embodiment, the nitrogen-containing substance is ammonium-nitrogen (NH4-N) and the correlation between the amount of phosphorous in the influent wastewater (C_{P, influent}) and the amount of ammonium-nitrogen (NH4-N) in the influent wastewater (C_{NH4, influent}) is equal to or less than 1:2 and equal to or more than 1:8, preferably equal to or less than 1:4 and equal to or more than 1:6, most preferably about 1:5. In this context, the correlation 1:5 is representative for municipal wastewaters of most EU-countries.

In a preferred embodiment, the coagulant is cerium trichloride (CeCl₃). It has been established that use of cerium trichloride may reduce the amount of the introduced coagulant by up to 30%. This depends at least partly on the fact that cerium trichloride is extremely reactive during first few seconds of its contact with the influent wastewater. Moreover, cerium trichloride is a coagulant that preserves a certain level of reactivity also when bound to the phosphorous-containing substance and settled in the sludge layer.

Further advantages and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic cross sectional side view of a multi-purpose basin suitable for a SBR-process with continuous inflow of influent, during a chemical treatment phase wherein the coagulant is being injected into the basin,

FIGS. 2-4 show correlation of the concentrations of nitrogen-containing substance and total phosphorous in municipal wastewater of Stockholm (Sweden), Cochranton (PA, USA) and El Monte (Chile), respectively.

### DETAILED DESCRIPTION OF PREFERRED EMBODIMENTS OF THE INVENTION

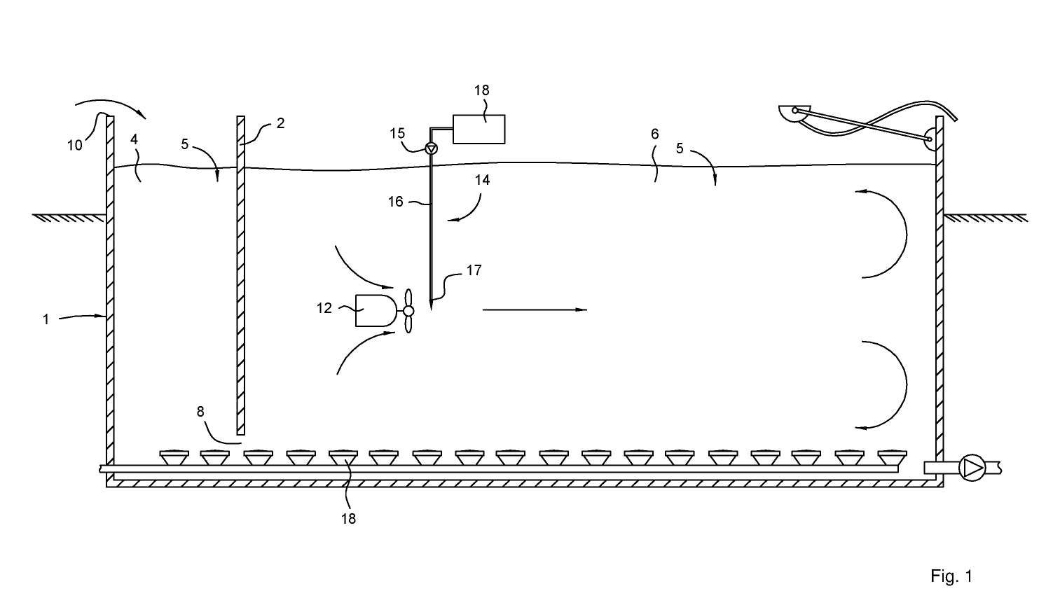

With reference to FIG. 1, a multi-purpose basin 1 suitable for SBR-process with continuous inflow of influent wastewater is shown. The basin 1 may be viewed as a bioreactor, i.e. a vessel that promotes biological reactions.

For the purposes of this application, the term influent is to be construed as encompassing any kind of municipal wastewater upstream of the basin 1. Hence, both wastewater entering the treatment plant as well as wastewater flowing into the basin 1 are comprised. As will become evident, the method isn't limited to be used in an SBR-process nor is the use of a single basin necessary for achieving above-discussed positive effects. In FIG. 1, a chemical treatment phase is in progress and the coagulant is being introduced into the basin 1. As it may be seen in this non-limiting embodiment, a partition wall 2 separates a first section 4 (pre-reaction zone) of the basin in which the influent wastewater is received and a second section 6 (main-reaction zone) in which the reaction phase takes place. The partition wall 2 is in its lowermost portion provided with apertures 8 enabling flow of liquid between the sections 4, 6. More particularly, it renders possible continuous flow from the first section 4 towards the second section 6. Obviously, a single section basin 1 (not shown), lacking a partition wall and being suitable for a conventional SBR-process, is equally conceivable.

The basin 1 is arranged to receive influent municipal wastewater 5 that is introduced into the basin 1 by bringing it to brim over the edge 10 on the left-hand side of FIG. 1. To ensure optimal distribution of the coagulant, it is preferably injected at a location that is in proximity to a mixing unit 12 such as the shown, submerged mechanical mixer. The coagulant is typically dissolved in a liquid such as water. Although a single mixer is disclosed, it is equally conceivable to employ a plurality of mixers.

An injection arrangement 14 comprises a pump 15 transferring, via a pipe 16 and a nozzle 17, the binding compound from a reservoir 18, positioned outside the basin, to the basin 1. In a related context, a plurality of aerator arrangements 18 is arranged in proximity to the bottom of the basin 1. These create aerobic conditions by releasing small air bubbles that oxygenate the influent. They may also participate in its mixing thus complementing or completely replacing the mechanical mixer 12.

As an alternative, water treatment of this type may be carried out in a plurality of basins. More specifically, the biological treatment phase may be carried out in a first location and the subsequent chemical treatment phase could be carried out in a second location positioned downstream of the location hosting the biological treatment phase. Furthermore, the basin 1 may be used in a CAS-process, but also as a ditch in a widely used oxidation ditch process where wastewater circulates in the basin 1 and substances are kept suspended in the wastewater by means of aeration devices.

An inherent property of the SBR-process with continuous inflow of influent is that the influent wastewater 5 may enter the multi-purpose basin 1 at any time during the biological treatment phase.

With reference to biological, respectively chemical treatment phase discussed in the Background-section, it is to be understood that the processes of consumption of carbon and nitrogen by the bacteria are not interrupted as long as the wastewater is present in the basin 1 whereas the consumption of phosphorous by the bacteria is only discontinued while coagulant is being introduced.

In the broadest embodiment, an amount of at least one nitrogen-containing substance in the influent wastewater (C_{N, influent}) is measured, and an amount of phosphorous to be removed from the influent wastewater (C_{P, influent}) is determined based on the measured amount of at least one nitrogen-containing substance in the influent wastewater (C_{N, influent}). It has been established that the amount of phosphorous in the influent wastewater is correlated with the amount of nitrogen-containing substances in the influent wastewater. As discussed above, this process parameter has historically been very difficult to determine in a simple manner and at a reasonable cost. Based on the insight that the amount of phosphorous in the influent wastewater (C_{P, influent}) and the amount of the nitrogen-containing substance in the influent wastewater (C_{NH4, influent}) are correlated and that the amount of the at least one nitrogen-containing substance is easily measured by means of a readily available sensor, the amount of phosphorous in the influent wastewater may be straightforwardly determined with great precision.

In an embodiment, the step of determining the amount of phosphorous to be removed from the influent wastewater (C_{P, influent}) further comprises subtracting a target value for the amount of phosphorous in the effluent wastewater (C_{P, target, effluent}) from the previously determined amount of phosphorous to be removed from the influent wastewater (C_{P, influent}). In a thereto related embodiment, the step of determining the amount of phosphorous to be removed from the influent wastewater (C_{P, influent}) further comprises adding a difference between the current measured value for amount of phosphorous in the effluent wastewater (C_{P, effluent}) and the target value for amount of phosphorous in the effluent wastewater (C_{P, target, effluent}) to the previously determined amount of phosphorous to be removed from the influent wastewater (C_{P, influent}).

The target value for the amount of phosphorous in the effluent wastewater (C_{P, target, effluent}) may be inferred using historical data or, more frequently, it may be imposed by the legislator in order to comply with a standard. The amount of phosphorus in the effluent wastewater (C_{P, effluent}) is measured either as a sample analysis in laboratory environment or as an online wet-chemistry-based test. Analysis can be done weekly as C_{P, effluent-values} do not vary significantly diurnally.

The determined amount of phosphorous may subsequently be removed from the influent wastewater (C_{P, influent}) using conventional methods. This is typically achieved by introducing an appropriate amount of coagulant during a chemical treatment phase of a reaction phase of the wastewater treatment process. Here, the introduced amount of coagulant is determined based on the previously determined amount of phosphorous to be removed from the influent wastewater (C_{P, influent}).

In the organic carbon fractionation table below, the purpose of which is in particular to facilitate understanding of the biological treatment phase described in the following, the classification of the organic carbon fractions possibly present in the process liquor is made with respect to different parameters, such as degree of biodegradability, the solubility in the liquor and molecular weight.

Total organic carbon

| Total biodegradable carbon | | | |
|---|---|---|---|
| Readily- | | | Total non- |
| biodegradable | | | biodegradable |
| carbon | Slowly biodegradable carbon | | carbon |
| Approximated to | | Approximated | Approximated |
| Dissolved organic carbon | | to Suspended | to Particulate |
| | | organic carbon | organic carbon |
| Low molecular | Medium to | Colloidal | Large particles |
| weight carbon | high molecular | organic carbon | (retained by |
| molecules | weight carbon | (filtered fraction | 1600 μm pores) |
| (filtered | (filtered fraction | between 1600 | |
| through | between 0.45 | and 0.45 μm | |
| 0.02 μm pore) | and 0.02 μm | pores) | |
| | pores) | | |

In another embodiment, the step of determining the amount of phosphorous to be removed from the influent wastewater (C_{P, influent}) further comprises subtracting a value corresponding to a biological uptake of phosphorous from the previously determined amount of phosphorous to be removed from the influent wastewater (C_{P, influent}), said biological uptake of phosphorous occurring during a biological treatment phase of the reaction phase of the wastewater treatment process.

The biological uptake of phosphorous occurring during the biological treatment phase is done by microorganisms. These microorganisms feed on the carbonaceous substance present in the wastewater while simultaneously uptaking phosphorous under the form of adenosine triphosphate (ATP), dry mass fraction content of phosphorous ranging between 1.5% and 2.0 The uptaken amount of phosphorous is dependent on the produced quantity of biomass, i.e. on the consumed amount of carbonaceous substance. In this context, the uptaken amount of phosphorous is typically expressed as correlated with a difference in the biological oxygen demand level (BOD-level) between the influent and the effluent wastewater. Here, the difference in the BOD-level quantifies the amount of oxygen used by microorganisms in the oxidation of carbonaceous substance.

In the same context, kinetics of the growth reaction may be described using a yield-parameter (Y) that describes efficiency of the growth reaction by linking the amount of biomass produced with the total amount of biodegradable carbon available. This yield is ranging between 0.2 and 1 and typically has a value of 0.4 g of biomass/g BOD. BOD can be calculated in real time using online equipment, or measured in laboratory environment using water samples. Analysis can be done weekly as BOD-values do not vary significantly diurnally.

Conclusively, the biological uptake is dependent on the difference in the BOD-level, growth of native microorganisms, the storage of phosphorous under the form of ATP and a yield-parameter describing the efficiency of the biological growth reaction.

As previously stated, subtracting the value corresponding to the uptaken amount of phosphorous from the previously determined amount of phosphorous to be removed from the influent wastewater contributes to reducing the amount of coagulant used in the subsequent chemical phase. In other words, taking into account the uptake of phosphorous during this phase opens for reduction of the amount of coagulant used in the subsequent chemical phase.

In a further embodiment, the step of determining the amount of phosphorous to be removed from the influent wastewater (C_{P, influent}) further takes into account a value corresponding to an uptake of phosphorous by phosphorous accumulating organisms (PAO), said uptake of phosphorous by phosphorous accumulating organisms (PAO) occurring during a biological treatment phase of the reaction phase of the wastewater treatment process. In this embodiment, the previously described biological uptake of phosphorous is not considered, and the step of determining the amount of phosphorous to be removed from the influent wastewater (C_{P, influent}) further comprises subtracting a value corresponding to an uptake of phosphorous by phosphorous accumulating organisms (PAO) from the previously determined amount of phosphorous to be removed from the influent wastewater (C_{P, influent}).

The phosphorous is uptaken under the form of organic polyphosphates by phosphorous accumulating organisms (PAO). More specifically, in an initial anaerobic stage, the PAOs accumulate readily-biodegradable carbon and produce acetate. Said readily biodegradable carbon is preferably being expressed by measurement of readily biodegradable chemical oxygen demand (rbCOD). The yield of acetate production is approximately 1.06 mg acetate/mg rbCOD. Still in the anaerobic stage, PAOs use stored polyphosphates as energy source and release phosphate back into the process liquor.

Upon aeration, i.e. in an aerobic stage, the PAOs use the acetate as energy source to store phosphorous as polyphosphates at a dry mass fraction content of 15 to 45%, typically 30%, and to grow biomass at a yield of 0.15 to 0.45, typically 0.30, mg of biomass/mg of acetate. Here, rbCOD can be 20 to 50% of the soluble COD. A fraction of the settled sludge is wasted prior to the start of a new cycle of the anaerobic biological treatment in order to discard a part of the phosphorus uptaken by the biomass.

In this context, the uptaken amount of phosphorous is typically also correlated with a difference between the value of readily biodegradable carbon present in the influent wastewater and the value of readily biodegradable carbon present in the effluent wastewater under anaerobic conditions, said readily biodegradable carbon preferably being expressed by means of readily biodegradable chemical oxygen demand (rbCOD). Here, the difference in the rbCOD-level quantifies the amount of carbonaceous substance used by PAOs under anaerobic conditions. rbCOD-measurements may be done in laboratory environment using water samples. These measurements are expected to be feasible in real time using online photospectrometral sensor operating with UV and/or visible light. Analysis can be done weekly as rbCOD-values do not vary significantly diurnally.

Conclusively, the PAO-related uptake of phosphorous is dependent on the difference in the rbCOD-level, growth of native microorganisms under the form of polyphosphates and a yield-parameter describing the efficiency of the biological growth reaction as a function of the acetate production. The uptake of phosphorous by PAOs can be 2 to 7 times larger than that by previously discussed, conventional biological uptake.

As previously stated, subtracting the value corresponding to the uptaken amount of phosphorous from the previously determined amount of phosphorous to be removed from the influent wastewater contributes to reducing the amount of coagulant used in the subsequent chemical phase. In other words, taking into account the uptake of phosphorous during this phase opens for reduction of the amount of coagulant used in the subsequent chemical phase.

In a further embodiment, the step of determining the amount of phosphorous to be removed from the influent wastewater (C_{P, influent}) further comprises taking into account a value corresponding to the biological uptake of phosphorous and a value corresponding to an uptake of phosphorous by phosphorous accumulating organisms (PAO). The duration of the anaerobic, anoxic and aerobic parts of the biological phase of the reaction phase of the wastewater treatment process are considered when determining uptake of phosphorous through biological uptake and/or through phosphorous accumulating organisms (PAO). Total anaerobic time per day as well as total aerobic time per day can be assessed by measurement of dissolved oxygen and nitrates in the process liquor. Duration and frequency of these time intervals may also be controlled with great precision. Accordingly, during aerobic and anoxic stages, the entire biomass grows on the slowly biodegradable carbon unused during the anaerobic stage, but also on the fresh biodegradable carbon load (readily as well as slowly biodegradable) coming in during the anoxic and aerobic stages. Moreover, during anaerobic stage, the PAOs grow through consumption of readily biodegradable carbon. Hereby, the amount of phosphorous uptaken during, in particular, anaerobic conditions may be predicted with better accuracy.

In an embodiment, the nitrogen-containing substance is ammonium-nitrogen (NH4-N) and the correlation between the amount of phosphorous in the influent wastewater (C_{P, influent}) and the amount of ammonium-nitrogen (NH4-N) in the influent wastewater (C_{NH4, influent}) is equal to or less than 1:2 and equal to or more than 1:8, preferably equal to or less than 1:4 and equal to or more than 1:6, most preferably about 1:5. In this context, the correlation 1:5 is representative for municipal wastewaters of most EU-countries. As an alternative, the nitrogen-containing substance could be at least one of organic nitrogen, ammonia (NH3) and ammonium (NH4+).

In an embodiment, the step of determining the amount of phosphorous to be removed from the influent wastewater (C_{P, influent}) further comprises subtracting a target value for the amount of phosphorous in the effluent wastewater (C_{P, target, effluent}) from the previously determined amount of phosphorous to be removed from the influent wastewater (C_{P, influent}). In a thereto related embodiment, the step of determining the amount of phosphorous to be removed from the influent wastewater (C_{P, influent}) further comprises adding a difference between the current measured value for amount of phosphorous in the effluent wastewater (C_{P, effluent}) and the target value for amount of phosphorous in the effluent wastewater (C_{P, target, effluent}) to the previously determined amount of phosphorous to be removed from the influent wastewater (C_{P, influent}).

The target value for the amount of phosphorous in the effluent wastewater (C_{P, target, effluent}) may be inferred using historical data or, more frequently, it may be imposed by the legislator in order to comply with a standard. Regardless, once said value has been set, it becomes possible to determine a more technologically and commercially relevant value for an amount of phosphorous that needs to be removed from the influent wastewater (C_{P, influent}). The dosing regime is then adjusted accordingly. Exemplifying the above, by virtue of the inventive method a realistic minimum target value for phosphorous concentration in the effluent (C_{P,target,effluent}) may be as low as 0.2-0.3 mg/L. It is in conjunction herewith to be noted that the EU-legislation lays down the value of 1.0 mg/L for maximum acceptable phosphorous concentration in the effluent. Typical values for phosphorous concentration removed by the biological treatment phase (C_{P, biological}) is about 3-4 mg/L and phosphorous concentration in the influent (C_{P, influent}) is of the order of 6-9 mg/L, respectively. Using these values, the phosphorous concentration of the liquid in the chemical treatment phase (C_{P, chemical}) may then be determined and is of the order of 2-4 mg/L. Above may also be used if the overall purpose of the wastewater treatment is to reduce, in a controlled manner, the volume of sludge needed to be disposed while maintaining an acceptable value for phosphorous concentration in the effluent.

The coagulant used for water treatment could be a salt, e.g. a chloride or a sulphate. Moreover, the coagulant may comprise a rare earth ion such as cerium, but it may also comprise a metal ion such as iron. In one embodiment, the coagulant may be cerium trichloride (CeCl₃) and molar ratio of cerium (Ce) and phosphorous (P) may be between 0.2 and 2, preferably 1. Use of cerium trichloride may reduce the amount of the injected coagulant by up to 30%. This depends at least partly on the fact that cerium trichloride is extremely reactive during first few seconds of its contact with the influent wastewater. Moreover, cerium trichloride is a coagulant that preserves a certain level of reactivity also when bound to the phosphorous-containing substance and settled in the sludge layer. As an alternative, iron trichloride (FeCl₃) may be used as coagulant and molar ratio of iron (Fe) and phosphorous (P) could be between 1 and 4, preferably 2.5.

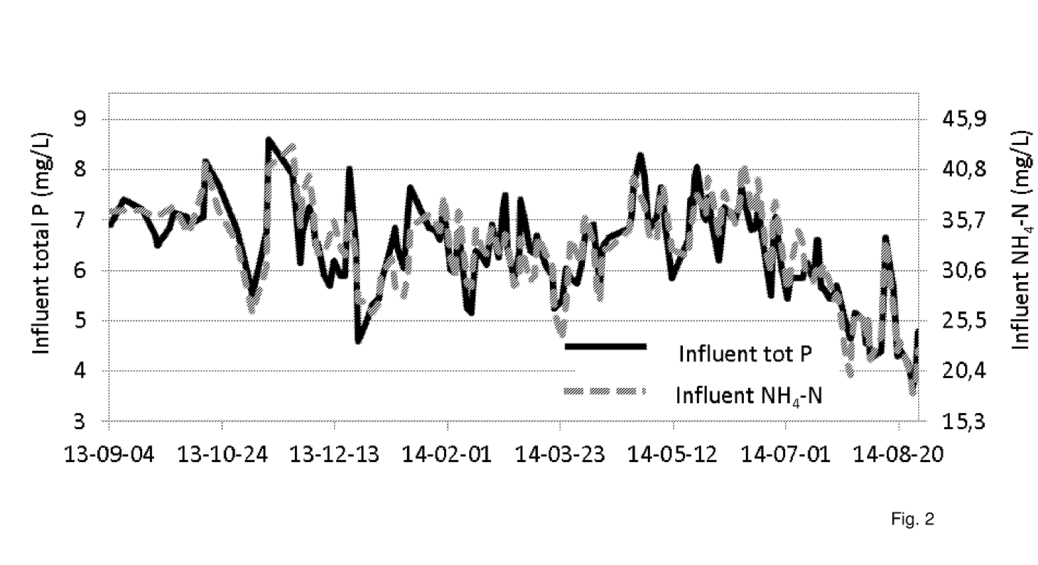

The following example, accompanied by FIGS. 2-4, is provided to illustrate certain embodiments and is not to be construed as introducing limitations on the embodiments. In the example, the term “concentration” is used to denominate the quantity of specific substance such as phosphorus or ammonium-nitrogen present in a volume unit of a mixture. On this background, it is to be understood that, at least for the purposes of this application, the terms “concentration” and “amount” are interchangeable.

### EXAMPLE 1

Introduction

The correlation of concentrations of a nitrogen-containing compound (dashed line) and total phosphorous (continuous line) in municipal influent wastewater has been investigated in an experiment using municipal wastewater of Stockholm (Sweden), Cochranton (PA, USA) and El Monte (Chile), respectively, as direct influent to a basin (bioreactor). The obtained results are visualised in FIGS. 2-4. In Stockholm and Cochranton the nitrogen-containing compound was ammonium nitrogen (NH₄-N) whereas the nitrogen-containing compound in El Monte was Total Kjeldahl nitrogen (TKN). As is known in the art, TKN is the sum of organic nitrogen, ammonia (NH₃), and ammonium (NH₄+) present in the tested sample. The level of respective nitrogen-containing compound in the wastewater was monitored for a period of twelve months.

The details of the monitoring were as follows:

Stockholm:

Continuous measurement of ammonia concentration, indirectly measured via NH₄-N, was done with an ISE probe containing NH₄-N and potassium (compensation ion) electrodes (Varion™ Plus 700 IQ, WTW). In this context, concentration of ammonia-nitrogen in wastewater is representative for determining concentration of ammonia (NH₃).

Measurement of total phosphorous concentration was made in a laboratory approximately four times per week using the standard method EV 08 SS-EN ISO 6878:2005.

Sample used for phosphorous analysis was a composite sample collected over a 24-hour period.

Cochranton:

Biweekly measurement of ammonia concentration, indirectly measured via NH₄-N, was done through laboratory analysis using standard EPA Method 350.1.

Measurement of total phosphorous concentration was done through laboratory analysis using the standard method EV 08 SS-EN ISO 6878:2005.

Sample used for phosphorous analysis was a composite sample collected over a 24-hour period.

El Monte:

Biweekly measurement of TKN-concentration was done through laboratory analysis using standard EPA Method 350.2.

Measurement of total phosphorous concentration was done through laboratory analysis using the standard method EV 08 SS-EN ISO 6878:2005.

Sample used for phosphorous analysis was a composite sample collected over a 24-hour period.

Results

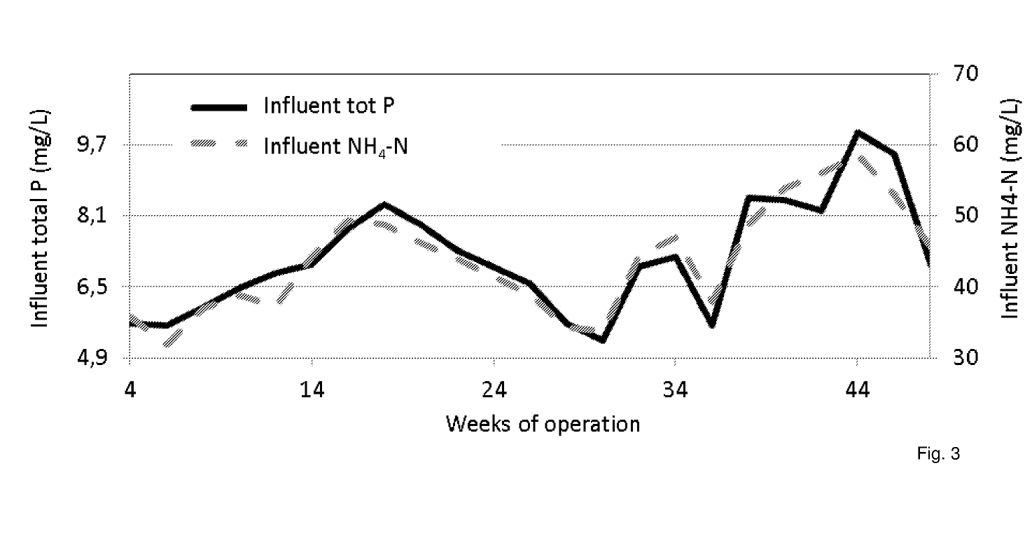

The results collected in Stockholm and Cochranton (visualised in FIGS. 2 and 3) demonstrate, independently of each other, that the concentrations of ammonia-nitrogen (dashed line) and total phosphorous (continuous line) in municipal wastewater are closely correlated.

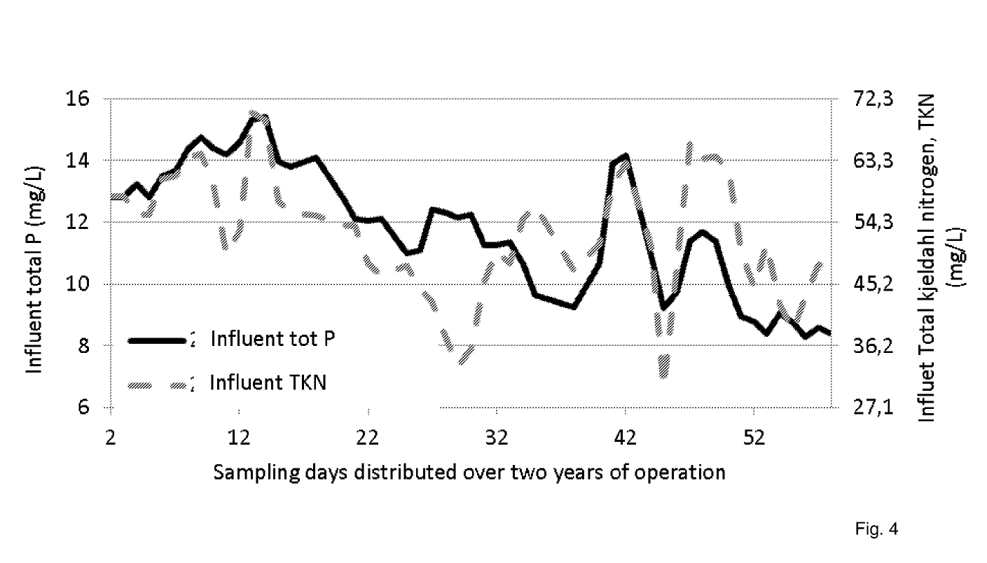

Results collected in El Monte (visualised in FIG. 4) demonstrate that a certain correlation exists between TKN (dashed line) and total phosphorous (continuous line) in municipal wastewater.

### Conclusions

Hence, the measurement of ammonia nitrogen is a reliable procedure to estimate the total phosphorous concentration in municipal wastewater. Moreover, the measurement of TKN gives valuable indications useful in estimating the total phosphorous concentration in municipal wastewater.

As listed in Table 1 below, the Stockholm-test established that the average, minimum and maximum mass ratios of ammonia-nitrogen and phosphorous in Stockholm municipal wastewater are 5,1; 3,7; and 6,5; respectively.

TABLE 1

| | | Total | |
|---|---|---|---|
| | Ammonia | phosphorous | Mass |
| | [N] | [P] | Ratio |
| | (mg/L) | (mg/L) | NH4:P |
| Average | 32.5 | 6.4 | 5.1 |
| Standard deviation | 5.8 | 1.1 | 0.5 |
| Minimum | 16.1 | 3.0 | 3.7 |
| Maximum | 53.3 | 10.3 | 6.5 |

In this context and as listed in Table 2 below, the Cochranton-test established that the average, minimum and maximum mass ratios of ammonia-nitrogen and phosphorous in Cochranton municipal wastewater are 6,2; 5,3; and 7,0; respectively.

TABLE 2

| | | Total | |
|---|---|---|---|
| | Ammonia | phosphorous | Mass |
| | [N] | [P] | ratio |
| | (mg/L) | (mg/L) | NH4:P |
| Average | 43.9 | 7.1 | 6.2 |
| Standard deviation | 9.1 | 1.6 | 0.6 |
| Minimum | 31.0 | 5.2 | 5.3 |
| Maximum | 64.0 | 12.0 | 7.0 |

The tests performed in El Monte, listed in Table 3 below, establish that the average, minimum and maximum mass ratios of TKN and phosphorous in municipal wastewater are 4,5; 2,7; and 6,9.

TABLE 3

| | | Total | |
|---|---|---|---|
| | TKN | phosphorous | Mass |
| | [N] | [P] | ratio |
| | (mg/L) | (mg/L) | TKN:P |
| Average | 52.3 | 11.8 | 4.5 |
| Standard deviation | 11.2 | 2.2 | 1.0 |
| Minimum | 28.2 | 8.0 | 2.7 |
| Maximum | 76.6 | 16.2 | 6.9 |

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even though it is not explicitly stated that features from a specific embodiment may be combined with features from another embodiment, the combination shall be considered obvious, if the combination is possible.

Throughout this specification and the claims which follow, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1.-20. (canceled)

21. A method for managing a wastewater treatment process, wherein an influent wastewater contains phosphorous, said method comprising at least the steps of:
measuring an amount of at least one nitrogen-containing substance in the influent wastewater (C_{N, influent}), wherein the at least one nitrogen-containing substance is at least one of ammonium-nitrogen (NH4-N), organic nitrogen, ammonia (NH3) and ammonium (NH4+), and
determining an amount of phosphorous to be removed from the influent wastewater (C_{P, influent}) based on the measured amount of the at least one nitrogen-containing substance in the influent wastewater (C_{N, influent}), based on a predetermined correlation between the amount of phosphorous (C_{P, influent}) and the amount of said at least one nitrogen-containing substance (C_{N, influent}) in the influent wastewater.

22. The method according to claim 21, said method further comprising the step of:
removing the determined amount of phosphorous from the influent wastewater (C_{P, influent}).

23. The method according to claim 21, wherein the step of determining the amount of phosphorous to be removed from the influent wastewater (C_{P, influent}) further comprises:
subtracting a target value for the amount of phosphorous in an effluent wastewater (C_{P, target, effluent}) from the previously determined amount of phosphorous to be removed from the influent wastewater (C_{P, influent}).

24. The method according to claim 23, wherein the step of determining the amount of phosphorous to be removed from the influent wastewater (C_{P, influent}) further comprises:
adding a difference between a current measured value for the amount of phosphorous in the effluent wastewater (C_{P, effluent}) and the target value for amount of phosphorous in the effluent wastewater (C_{P, target, effluent}) to the previously determined amount of phosphorous to be removed from the influent wastewater (C_{P, influent}).

25. The method according to claim 24, wherein the step of removing the determined amount of phosphorous from the influent wastewater (C_{P, influent}) further comprises:
introducing an amount of coagulant during a chemical treatment phase of a reaction phase of the wastewater treatment process, wherein the introduced amount of coagulant is determined based on the previously determined amount of phosphorous to be removed from the influent wastewater (C_{P, influent}).

26. The method according to claim 25, wherein the step of determining the amount of phosphorous to be removed from the influent wastewater (C_{P, influent}) further comprises:
subtracting a value corresponding to a biological uptake of phosphorous from the previously determined amount of phosphorous to be removed from the influent wastewater (C_{P, influent}), said biological uptake of phosphorous occurring during a biological treatment phase of the reaction phase of the wastewater treatment process.

27. The method according to claim 26, wherein said biological uptake of phosphorous is based at least on consumed biodegradable carbon expressed by biological oxygen demand (BOD).

28. The method according to claim 27, wherein the step of determining the amount of phosphorous to be removed from the influent wastewater (C_{P, influent}) further comprises:
subtracting a value corresponding to an uptake of phosphorous by phosphorous accumulating organisms (PAO) from the previously determined amount of phosphorous to be removed from the influent wastewater (C_{P, influent}), said uptake of phosphorous by phosphorous accumulating organisms (PAO) occurring during a biological treatment phase of the reaction phase of the wastewater treatment process.

29. The method according to claim 28, wherein said uptake of phosphorous by phosphorous accumulating organisms (PAO) is based at least on the difference between the value of readily biodegradable carbon present in the influent wastewater and a value of readily biodegradable carbon present in the effluent wastewater under anaerobic conditions, said readily biodegradable carbon being expressed by way of readily biodegradable chemical oxygen demand (rbCOD).

30. The method according to claim 29, wherein the step of determining the amount of phosphorous to be removed from the influent wastewater (C_{P, influent}) further comprises:
taking into account a duration of the anaerobic part of the biological phase of the reaction phase of the wastewater treatment process when determining uptake of phosphorous through (i) biological uptake, (ii) phosphorous accumulating organisms (PAO), (iii) or both biological uptake and PAO.

31. The method according to claim 21, wherein the at least one nitrogen-containing substance is ammonium-nitrogen (NH4-N).

32. The method according to claim 31, wherein the correlation between the phosphorous concentration of the influent wastewater (C_{P, influent}) and the concentration of ammonium-nitrogen (NH4-N) in the influent wastewater (C_{NH4, influent}) is equal to or less than 1:2 and equal to or more than 1:8.

33. The method according to claim 32, wherein the nitrogen-containing substance is at least one of organic nitrogen, ammonia (NH3) and ammonium (NH4+).

34. The method according to claim 25, wherein the coagulant is a rare earth salt that comprises a cerium ion.

35. The method according to claim 34, wherein a molar ratio of cerium (Ce) and phosphorous (P) is between 0.2 and 2.

36. The method according to claim 25, wherein the coagulant is cerium trichloride (CeCl₃).

37. The method according to claim 25, wherein the coagulant is a metal salt that comprises an iron ion.

38. The method according to claim 37, wherein a molar ratio of iron (Fe) and phosphorous (P) is between 1 and 4.

39. The method according to claim 25, wherein the coagulant is iron trichloride (FeCl₃).

40. The method according to claim 21, wherein the step of determining amount of phosphorous to be removed from the influent wastewater (C_{P, influent}) further comprises:
measuring a level of biodegradable carbon in the influent wastewater (C_{N, influent}), and
subtracting the measured level of biodegradable carbon in the influent wastewater (CN, influent) from the previously determined amount of phosphorous in the influent wastewater (C_{P, influent}).
